(19) United States
(12) Patent Application Publication
(10) Pub. No.: US 2008/0265558 A1
(43) Pub. Date: Oct. 30, 2008

(54) Memorial album " Grief Work " Journal Day Planner

(75) Inventor: Betty Lou Merritt, Baltimore, MD (US)

Correspondence Address: Betty Lou Merritt, 3212 Burleith Avenue, Baltimore, MD, 21215, US

(73) Assignee: Betty Lou Merritt, Baltimore, MD (US)

(21) Appl. No.: 11/700,168

(22) Filed: Jan. 30, 2007

(51) Int. Cl. B42D 1/08

(52) U.S. Cl. 281/22

(57) ABSTRACT

This is a new and unique way of working through the process of grieving. The unique features are: a record of the family tree can be reserved, and the Album can assist loved ones left behind to moan the loss of all of their loved ones.

This includes the loss of a beloved pet.

The album is enclosed in a black Vinyl/Leather carrying case that has Gold Typography stamp of the name of the binder, and a gold family image on the front cover. The back of the album has a clear vinyl pocket designed to keep the obituary of the deceased. The inside of the Memorial Album “Grief Work” Journal Day Planner, has a pocket which holds the spiral bound book of the album itself. There are also tab dividers to include notes on journalizing and a beautiful black and gold pen.

This invention can be revised to please anyone who acquires the license.

The Memorial Album “Grief Work” Journal Day Planner was developed specifically to provide consumers a simple way in which to express their sorrow through journalizing in their own words. The album is designed to be a library of record on the life of the deceased.

The front cover has a gold typography stamp of the name of the album.

The album is covered with black vinyl (Or leather), and is held securely closed with a large soap.

On the left inside cover there is a pocket which houses a spiral bound grief manual.

The various pages of the text are essentially blank, however, words of encouragement, Tutorials for various copying exercises, as well as helpful hints for completing the journal Are inscribed on the pages of the text.

On the right inside cover there is a loop holder which stores a black ink pen with the gold image stamp of the family.

Metal rings in the center holds dividers for journalizing notes, the family grief work project of researching the family tree, and blank lined paper for journalizing notes.

There is a special divider for pet journalizing found here

On the back cover there is a clear plastic cover which can hold a standard size obituary.

Additional filler pages for the Memorial Album “Grief work” Journal Day Planner are available if needed.

Use of the Memorial Album “Grief Work” Journal Day Planner is simple and straight forward. Following the death of a loved one, the user utilizes the Memorial Album “Grief work” Journal Day Planner as a practical outlet with which to express their grief. There are ample pages to include memento's of the deceased (human or pet).

The Memorial Album “Grief Work” Journal Day Planner enables consumers to accept the reality of the loss, while gaining an understanding of how to go on with their own life.

The Memorial Album “Grief Work” Journal Day Planner serves as a tangible reminder of one lost, as well as heartfelt memento's to be passed down through, generations—offering future generations a glimpse into the lives of their ancestors.

Offering a practical asset when dealing with a loss of a loved one, the Memorial Album “Grief Work” Journal Day Planner is a practical product which enables the consumer to make sense of their grief, while providing a lasting tribute to the departed.

Simple to use, this beautiful Memorial Album “Grief Work” Journal Day Planner could prove an invaluable commodity to anyone who is dealing with a sudden or expected Loss.

The Memorial Album. “Grief Work” Journal Day Planner should be well received by the general consumer populace, particularly those who have suffered a loss.

### BRIEF DESCRIPTION OF DRAWINGS

FIG. 1

The front cover has gold typography stamp of the name of the binder.

FIG. 11.

Left inside cover pocket.

FIG. 111.

The spiral binder (the Memorial Album).

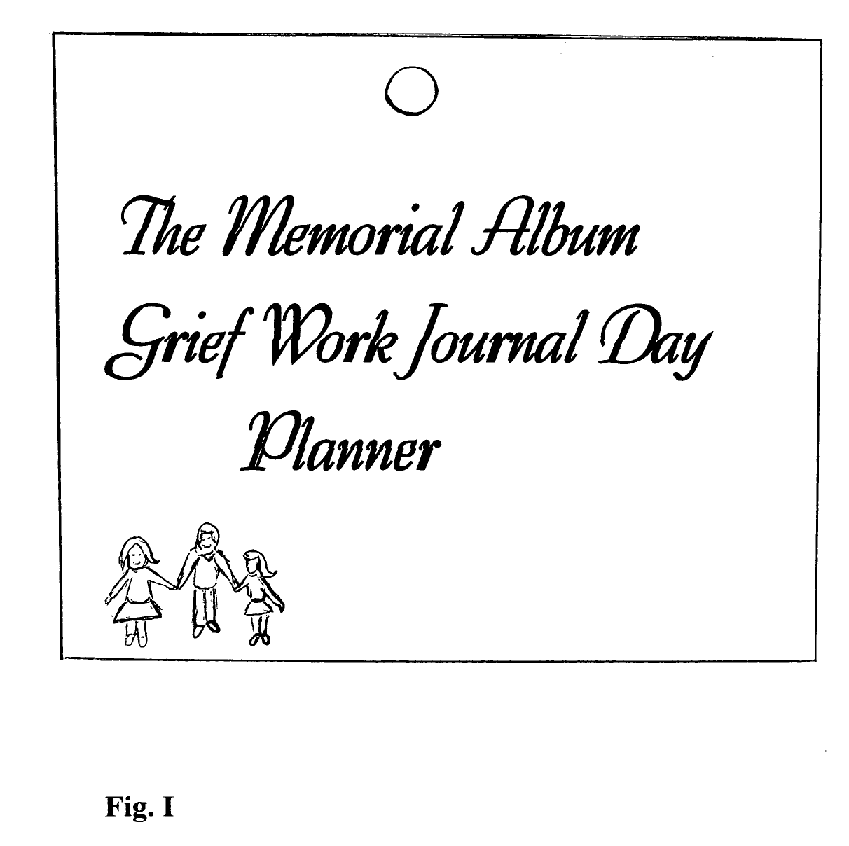

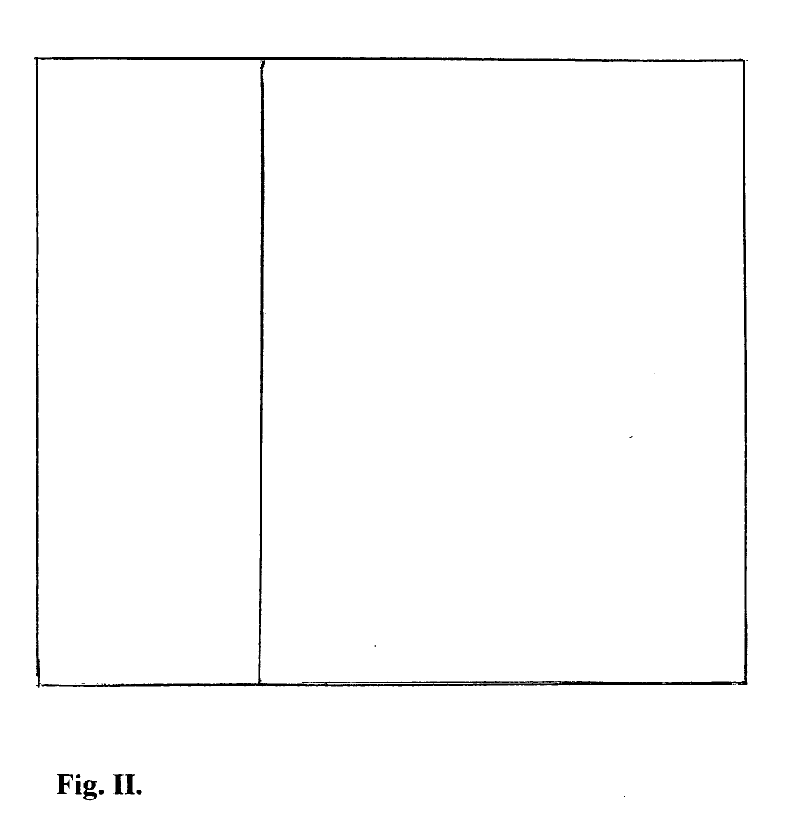

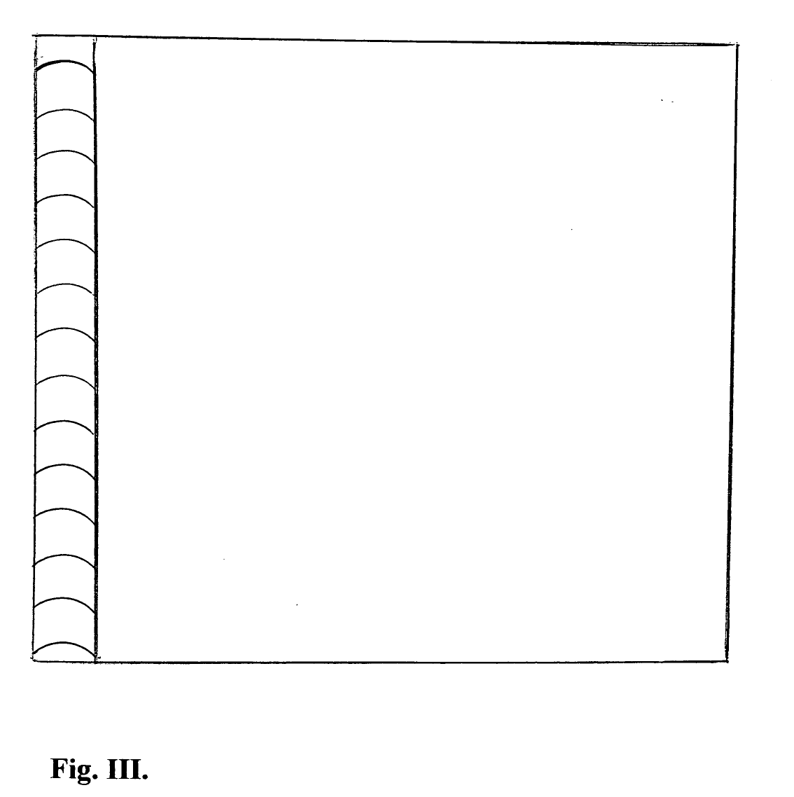

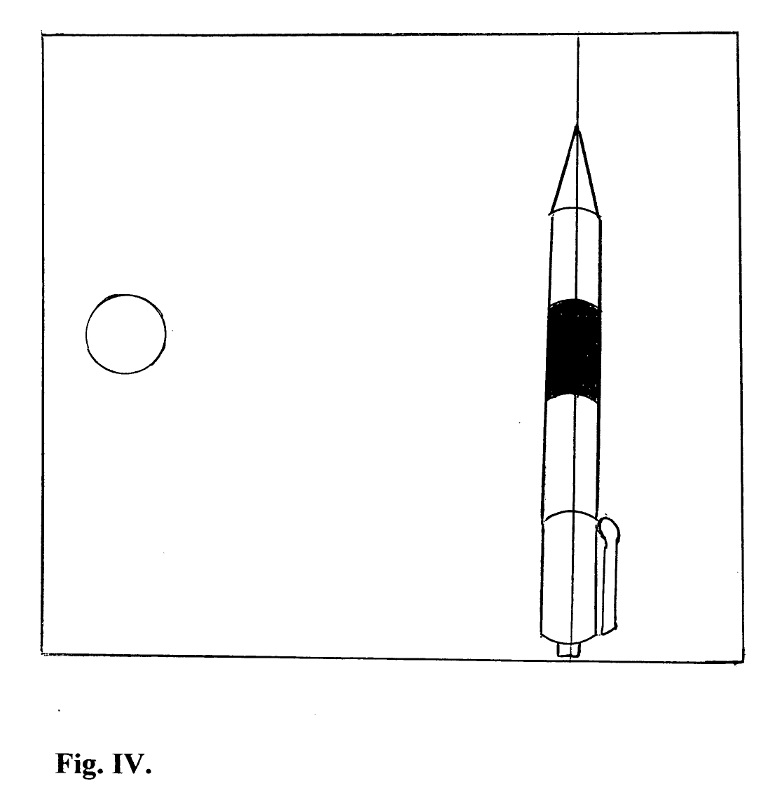

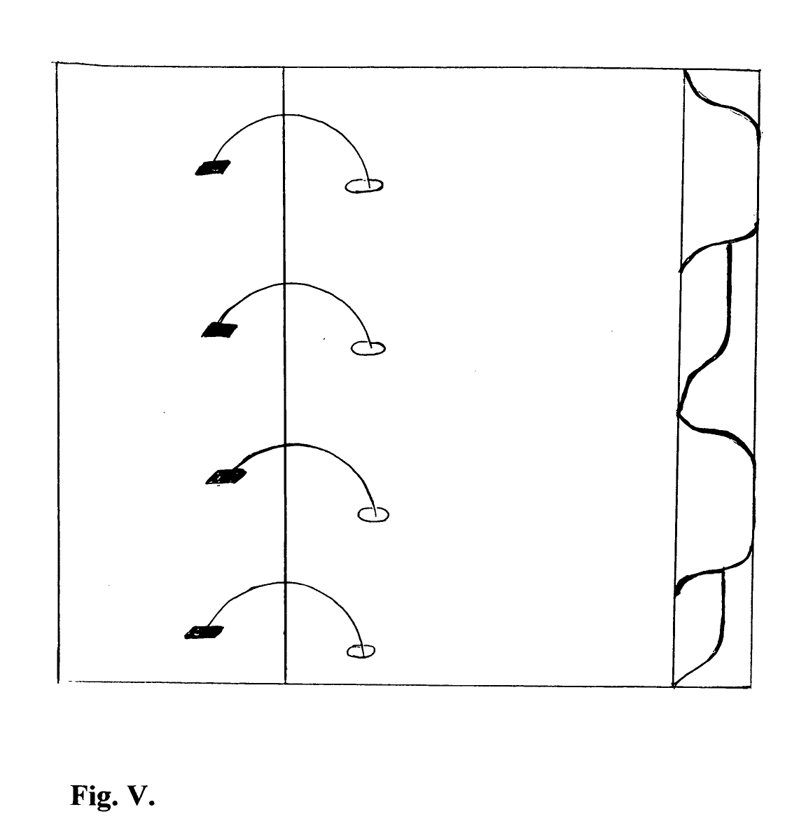

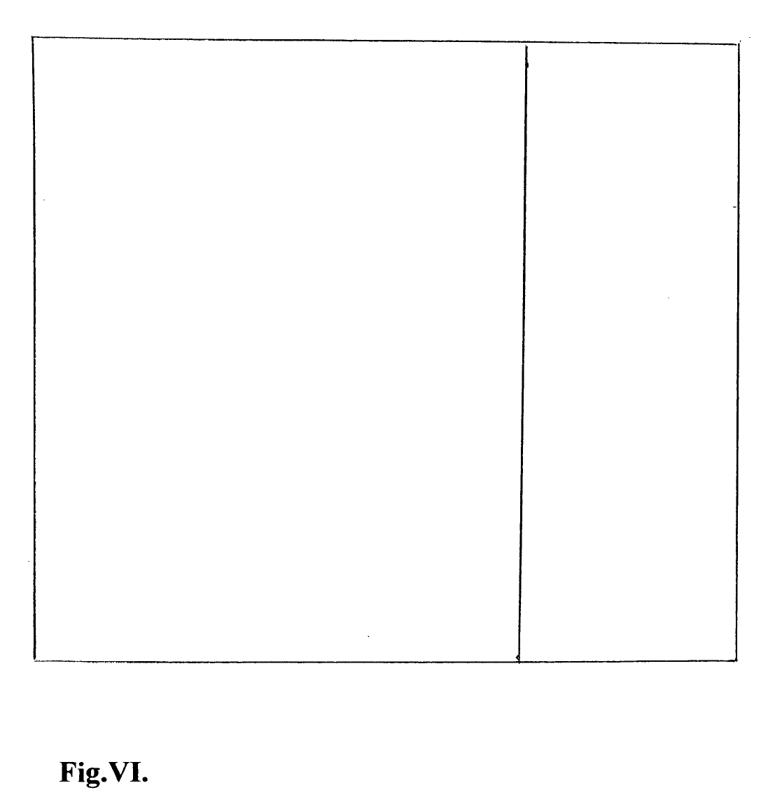

FIG. 1V.

Loop holder with a pen.

Fig V.

Metal rings in the center of the binder.

FIG. V1.

Clear plastic pocket.

I. Novelty Requirement
This product meets the novelty requirement because it is a new invention produced for the first time in the United States of America by Betty Lou Merritt.

II. None obviousness
There is a minimal difference in my invention compared to “Prior art” It has a special section to include deceased pets, it serves as a library of record of the life of the deceased by preserving the obituary, and also Provides a record of the family tree. Thus all future generations can have A central record of their ancestors.
